(19) United States
(12) Patent Application Publication
(10) Pub. No.: US 2013/0346202 A1
(43) Pub. Date: Dec. 26, 2013

(54) Automated IPv6, IPv4 Address Classifier

(71) Applicants: Kambiz Kouladjie, Seattle, WA (US); Ramu Movva, Redmond, WA (US); Ali Haveliwala, Sammamish, WA (US); Haitao Song, Sammamish, WA (US)

(72) Inventors: Kambiz Kouladjie, Seattle, WA (US); Ramu Movva, Redmond, WA (US); Ali Haveliwala, Sammamish, WA (US); Haitao Song, Sammamish, WA (US)

(73) Assignee: MICROSOFT CORPORATION, Redmond, WA (US)

(21) Appl. No.: 13/527,645

(22) Filed: Jun. 20, 2012

(51) Int. Cl. G06Q 30/02

(52) U.S. Cl. 705/14.55

(57) ABSTRACT

Various embodiments pertain to techniques for automatically classifying an IP address using information received as part of a request for an advertisement. In some embodiments, the information received can include an IP address associated with the request, a client identifier, and a unique request identifier, such as a request global user identifier (RGUID). In various embodiments, the information is analyzed and used to classify the IP address. For example, the IP address can be classified as belonging to a unique or real end user, belonging to a proxy, or belonging to a potential exploit. Advertisements can be served, or not served at all, according to the classification of the IP address. In various embodiments, some classifications of IP addresses can be further analyzed to determine a geo-location associated with the IP address or to enable processes to mitigate malicious or fraudulent request risks.

### BACKGROUND

Many search engine web pages include sponsored results or other advertisements on a search engine results page. These advertisements can be a major source of revenue for a search engine provider. Typically, the search engine matches advertisements to a given user's query and displays the advertisements along with search results on the search engine results page. The advertisements commonly appear above non-paid search results or organic search results, or down a side of the search results pages, e.g., down the right-hand side of the search results page. Advertisements can also be served on other types of web pages and/or in conjunction with applications or web-based services.

Because publishers are commonly paid on a per-selection basis, the number and location of advertisements can affect publisher revenue and advertiser's budgets along with the relevancy of the advertisement to a user's query. For example, advertiser's budgets can be wasted if advertisements are served in situations where there is no user viewing the advertisement (e.g., a click bot using a script to request advertisements). As another example, a device's unique, numerical internet protocol (IP) address may provide inaccurate location information regarding the device and prevent an advertisement targeted for the location of the device from being served in favor of an advertisement targeted for another location, such as a location of a proxy through which the request for the advertisement was passed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to techniques for automatically classifying an IP address using information received as part of a request for an advertisement. In some embodiments, the information received can include an IP address associated with the request, a client identifier, and/or a unique request identifier, such as a request global user identifier (RGUID). In various embodiments, the information is analyzed and used to classify the IP address. For example, the IP address can be classified as belonging to a unique or real end user, belonging to a proxy, or belonging to a potential exploit. Advertisements can be served, or not served at all, according to the classification of the IP address. In various embodiments, some classifications of IP addresses can be further analyzed to determine a geo-location associated with the IP address or to enable processes to mitigate malicious or fraudulent requests.

In various embodiments, when an advertisement is consumed (e.g., selected or displayed in the case of an image or animation, executed in the case of a script or clicked on), IP address information received as part of feedback resulting from the consumption of the advertisement can similarly be classified effective to validate a selection or click or determine that the selection or click resulted from fraudulent or malicious behavior. For example, the IP address associated with the feedback and a unique request identifier, such as a RGUID associated with the consumed advertisement, can be classified in order to either validate that the consumption was received from an end user (e.g., the advertiser can be charged) or to determine that the consumption was the result of a test or fraudulent or malicious behavior (e.g., the advertiser cannot be charged for the selection or click).

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 illustrates an example operating environment in accordance with one or more embodiments;

FIG. 2 illustrates an example process for requesting an ad impression in accordance with one or more embodiments;

FIG. 3 illustrates an example process for classifying an IP address based on information received as part of the request for the web page in accordance with one or more embodiments;

FIG. 4 illustrates an example process for determining a geo-location for an IP address in accordance with one or more embodiments;

FIG. 5 illustrates an example process for managing risk responsive to classifying an IP address as associated with a malicious or fraudulent user in accordance with one or more embodiments;

FIG. 6 depicts an example process for using feedback information to validate IP classifications; and

FIG. 7 depicts an example device that can be used to implement one or more embodiments.

### DETAILED DESCRIPTION

### Overview

Various embodiments pertain to techniques for automatically classifying an IP address using information received as part of a request for an advertisement. In some embodiments, the information received can include an IP address associated with the request, a client identifier, and/or a unique request identifier, such as a request global user identifier (RGUID). In various embodiments, the information is analyzed and used to classify the IP address. For example, the IP address can be classified as belonging to a unique or real end user, belonging to a proxy, or belonging to a potential exploit. A potential exploit can be, for example, a click bot configured to select advertisements in order to spend an advertiser's budget without having provided advertisements to real users, or other malicious or fraudulent requests for advertisements. Advertisements can be served, or not served at all, according to the classification of the IP address. In various embodiments, some classifications of IP addresses can be further analyzed to determine a geo-location associated with the IP address or to enable processes to mitigate malicious or fraudulent requests.

In various embodiments, when an advertisement is consumed (e.g., displayed, executed, or clicked on), IP address information received as part of feedback resulting from the consumption of the advertisement can similarly be classified effective to validate a selection or click or determine that the selection or click resulted from fraudulent or malicious behavior. For example, the IP address associated with the feedback and a unique request identifier, such as a RGUID associated with the consumed advertisement, can be classified in order to either validate that the consumption was received from an end user (e.g., the advertiser can be charged) or to determine that the consumption was the result of a test or fraudulent or malicious behavior (e.g., the advertiser cannot be charged for the selection or click).

In the discussion that follows, a section entitled “Example Operating Environment” describes an operating environment in accordance with one or more embodiments. Next, a section entitled “Impression Path” describes various embodiments of classifying an IP address from which a request for an advertisement is received, and determining an advertisement to be served based on the classification. A section entitled “Selection Path” describes various embodiments of classifying an IP address from which a selection, or a consumption of the ad, is received, and processing the selection data according to the classification. Finally, a section entitled “Example Device” describes an example device that can be used to implement one or more embodiments.

Consider an example operating environment in accordance with one or more embodiments.

### Example Operating Environment

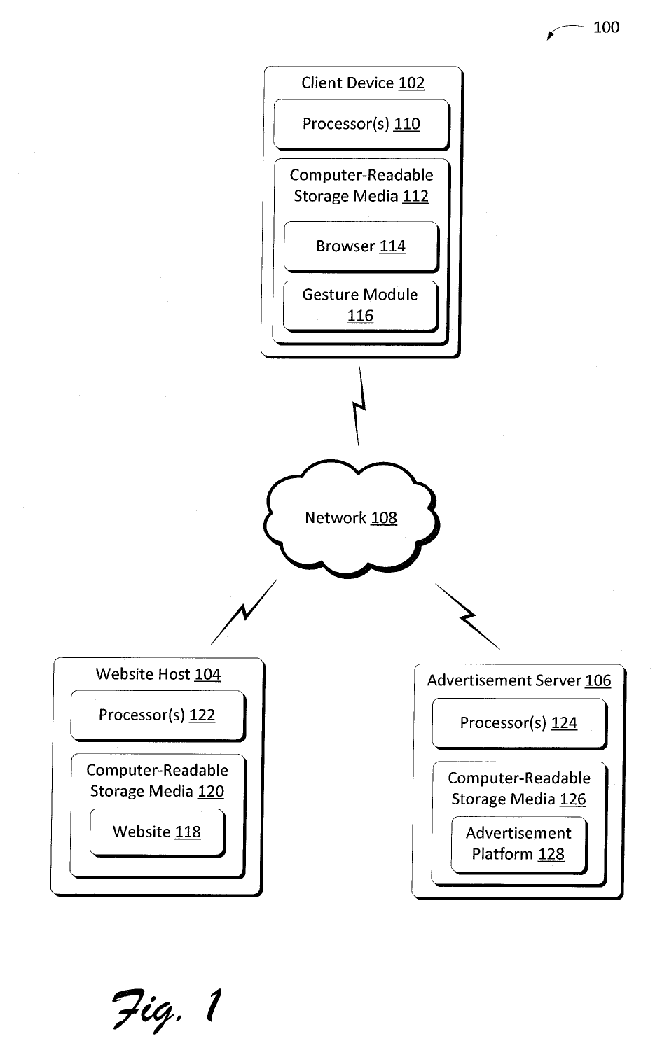

FIG. 1 is an illustration of an example environment 100 in accordance with one or more embodiments. Environment 100 includes a client device 102 communicatively coupled to a website host 104 and an advertisement server 106 through a network 108.

Client device 102 can include one or more processors 110 and computer-readable storage media 112 and may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth.

Computer-readable storage media 112 includes one or more software applications, which can include a software executable module in the form of a browser 114. Browser 114 can receive content from and send content to network devices, such as website host 104 and advertisement server 106, via network 108, such as the Internet or an intranet. Each device connected to network 108 has a unique IP address, which is transmitted as part of each request sent and received via network 108. In various embodiments, browser 114 is configured to request a web page (such as a page of website 118 hosted by website host 104) that includes at least one advertisement slot or ad impression.

Computing device 102 also includes a gesture module 116 that recognizes gestures that can be performed by one or more fingers, and causes operations to be performed that correspond to the gestures. The gestures may be recognized by gesture module 116 in a variety of different ways. For example, the gesture module 116 may be configured to recognize a touch input, such as a finger of a user's hand as proximal to a display device of the computing device 102 using touchscreen functionality. Gesture module 116 can be utilized to recognize single-finger gestures and bezel gestures, multiple-finger/same-hand gestures and bezel gestures, and/or multiple-finger/different-hand gestures and bezel gestures.

The computing device 102 may also be configured to detect and differentiate between a touch input (e.g., provided by one or more fingers of the user's hand) and a stylus input (e.g., provided by a stylus). The differentiation may be performed in a variety of ways, such as by detecting an amount of the display device that is contacted by the finger of the user's hand versus an amount of the display device that is contacted by the stylus.

Thus, the gesture module 116 may support a variety of different gesture techniques through recognition and leverage of a division between stylus and touch inputs, as well as different types of touch inputs.

Ad impressions may be impression opportunities that can include any form or type of space or region on a web page. The impression opportunity may overlap with, reside within, or be part of content on the web page (e.g., locations for banners, ad blocks, sponsored listings, margin ads, flash displays, and the like), although in some embodiments, the impression opportunity may not directly reside on a web page. For example, in some embodiments, an impression opportunity in the form of a pop up window may be generated in response to a user action, such as clicking a button on an input device or causing a mouse indicator to hover over a particular portion of the web page. In some embodiments, the impression opportunity is temporal, e.g., associated with a time slot, such as before a requested video clip or at a particular time of day.

Website host 104 includes computer-readable storage media 120 and one or more processors 122. Computer-readable storage media 120 includes one or more executable modules, such as website 118, which can be executed under the influence of the one or more processors 122. In particular, website 118 can provide content, such as text, images, and multi-media presentations for rendering by browser 114. Various web pages that make up website 118 include ad impressions through which website host 104 can generate revenue. For example, an advertiser may pay a set price for each selection of an advertisement displayed on website 118. In various embodiments, advertisements are filled into the ad impressions by an advertisement server, such as advertisement server 106. For example, responsive to receiving a request for a web page from client device 102, website host 104 can request an advertisement (e.g., initiate an AdCall) from advertisement server 106.

Advertisement server 106 includes one or more processors 124 configured to execute software modules residing on computer-readable storage media 126. For example, the one or more processors 124 can execute advertisement platform 128 to cause the advertisement platform 128 to analyze information received as part of a request for an advertisement or feedback resulting from the consumption of an advertisement and, based on the received information, classify an IP address for client device 102. In some embodiments, advertisement platform 128 can determine that the request for an advertisement was received or otherwise originated from a client device being used by a user and can select an advertisement to be served according to the user's location. In other embodiments, advertisement platform 128 can determine that the request for the advertisement was received from a test bot or a fraudulent or malicious source and can determine that no advertisement should be served. In some such embodiments, the IP address from which the request was received can be added to a blacklist or other listing to mitigate responses to fraudulent attempts originating from that particular IP address. In still other embodiments, advertisement platform 128 can determine that the IP address belongs to a proxy through which the request from the client device was passed. Classification of the IP address and subsequent processes associated with the classification are described in more detail below.

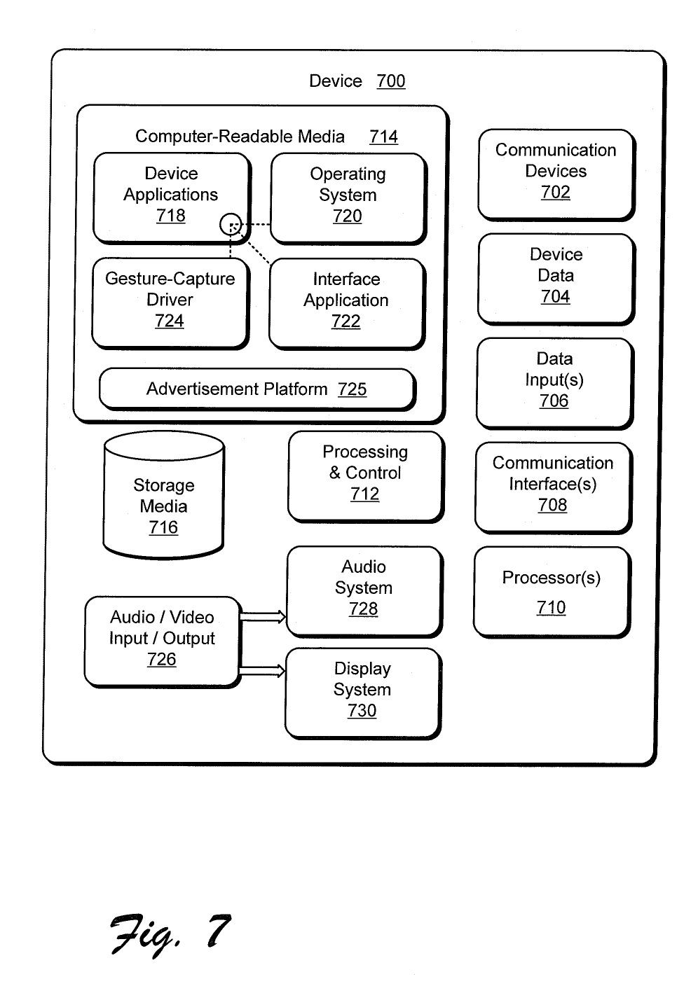

The computer-readable storage media included in each device or server can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 7.

In various embodiments, techniques described herein can be implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described, the client device 102 may be configured in a variety of different ways, such as for mobile, computer, and television uses. Each of these configurations has a generally corresponding screen size and thus the client device 102 may be configured as one of these device classes. For instance, the client device 102 may assume the mobile class of device which includes mobile telephones, music players, game devices, and so on. The client device 102 may also assume a computer class of device that includes personal computers, laptop computers, netbooks, and so on. The television configuration includes configurations of device that involve display in a casual environment, e.g., televisions, set-top boxes, game consoles, and so on. Thus, the techniques described herein may be supported by these various configurations of the client device 102 and are not limited to the specific examples described in the following sections.

In various embodiments, a cloud including a platform for web services may be included in the environment 100. The platform abstracts underlying functionality of hardware (e.g., servers) and software resources of the cloud and thus may act as a “cloud operating system.” For example, the platform may abstract resources to connect the client device 102 with other computing devices. The platform may also serve to abstract scaling of resources to provide a corresponding level of scale to encountered demand for the web services that are implemented via the platform. A variety of other examples are also contemplated, such as load balancing of servers in a server farm, protection against malicious parties (e.g., spam, viruses, and other malware), and so on. Thus, the cloud is included as a part of the strategy that pertains to software and hardware resources that are made available to the client device 102 via the Internet or other networks.

The gesture techniques supported by the gesture module may be detected using touchscreen functionality in the mobile configuration, track pad functionality of the computer configuration, detected by a camera as part of support of a natural user interface (NUI) that does not involve contact with a specific input device, and so on. Further, performance of the operations to detect and recognize the inputs to identify a particular gesture may be distributed throughout the environment, such as by the client device 102 and/or other devices connected to the network 108.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer-readable memory devices. The features of the gesture techniques described below are platform-independent, meaning that the techniques may be implemented on a variety of commercial computing platforms having a variety of processors.

Environment 100 is referenced by the following description of various embodiments in which IP addresses are automatically classified and classifications are used to determine an applicable ad impression path.

Impression Path

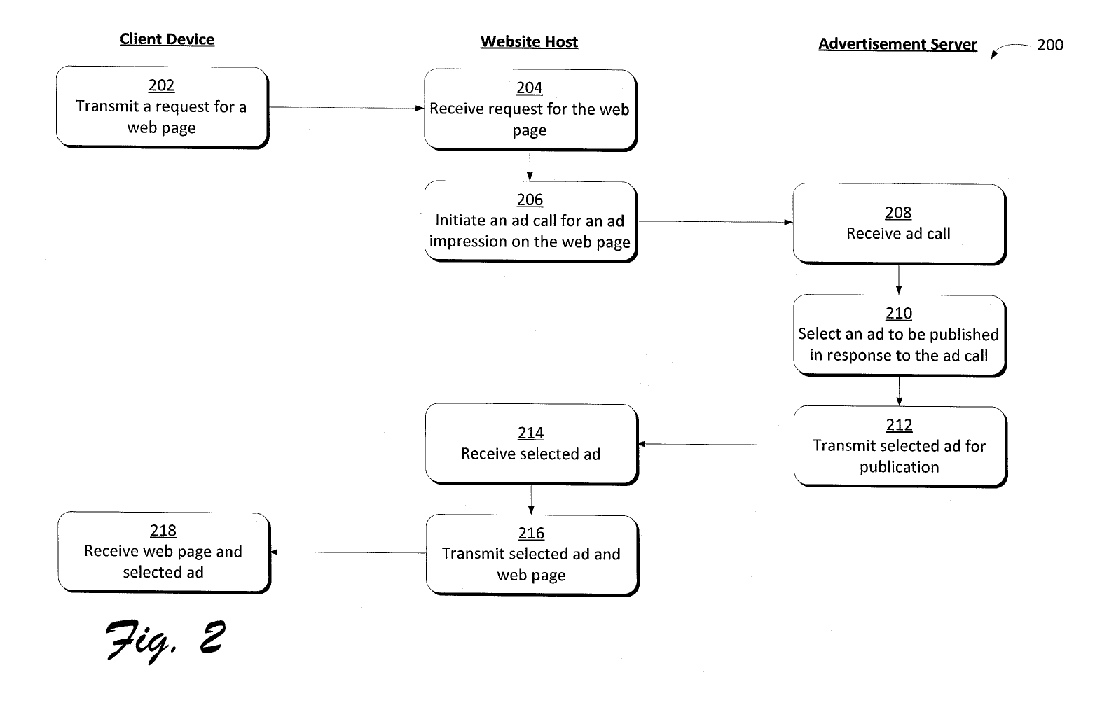

FIG. 2 illustrates an example process 200 for requesting an ad impression in accordance with one or more embodiments. The process can be implemented in connection with any suitable hardware, software, firmware, or combination thereof. In at least some embodiments, the process can be implemented in software. In FIG. 2, various steps in the process are indicated as being performed by a “Client Device,” a “Website Host,” or an “Advertisement Server.”

Block 202 transmits a request for a web page. This can be performed in any suitable way. For example, browser 114 on client device 102 can transmit a request for a web page via network 108 upon receiving input, such as that received from a user. For example, a user can enter a uniform resource locator (URL) into an address bar of a browser interface or select a link to a website, such as website 118.

Block 204 receives a request for the web page that includes at least one advertisement slot. This can be performed in any suitable way. For example, website host 104 can receive the request for a web page that is part of website 118 via network 108.

Next, block 206 initiates an ad call for an ad impression on the web page. This can be performed in any suitable way. For example, website host 104 can send a request for an advertisement to advertisement server 106 via network 108. In various embodiments, the web page can include multiple advertisement slots and block 206 initiates an ad call for multiple ad impressions on the web page. In some embodiments, individual ad calls can be initiated for each ad impression on the web page.

Block 208 receives the ad call. This can be performed in any suitable way. For example, advertisement server 106 can receive a request for one or more advertisements via network 108.

Block 210 selects an ad to be published in response to the ad call. This can be performed in any suitable way. For example, advertisement platform 128 can select an advertisement from a database to be served as part of the web page. The advertisement can be selected according to a variety of factors, such as keywords contained in the web page, advertiser bidding on the website, demographic or other information regarding a user requesting the web page, or the like. In some embodiments, such as when the web page requested is a search engine results page (SERP), the advertisement can be selected according to keywords contained in a user query. In various embodiments, multiple ads can be selected for publication in response to the ad call.

In various embodiments, advertisement platform 128 considers information received as part of the ad call in order to select an advertisement. In particular, advertisement platform 128 can analyze information received as part of the ad call in order to determine a classification for the IP address and serve an advertisement based on the classification. Information received as part of the ad call used for classifying the IP address can include, by way of example and not limitation, the IP address of the device requesting the web page, a client identifier (e.g., a client ID, machine unique identifier (MUID), globally unique identifier (GUID), user ID such as a username for a service, or identification information included in a cookie), and/or a request identifier or request global user identifier (RGUID).

In some embodiments, advertisement platform 128 can determine that the IP address belongs to a malicious user (e.g., a confirmed malicious user) and, responsively, selects no advertisement or a blank advertisement. In alternate embodiments, advertisement platform 128 can determine that the IP address belongs to a NAT or proxy and can select an advertisement according to an advertiser market or distribution channel rather than according to a specific location associated with the IP address. In still other embodiments, advertisement platform 128 can determine that the IP address belongs to an end user, or a client device, and can select an advertisement applicable to the user or client device. For example, an advertisement targeted to the location of the IP address can be selected. Additional details on the classification of IP addresses and the use of the classification to select an advertisement is provided below.

Next, block 212 transmits the selected ad for publication. This can be performed in any suitable way. For example, advertisement server 106 can transmit the advertisement to website host 104 via network 108.

Block 214 receives the selected ad. This can be performed in any suitable way. For example, website host 104 can receive the ad selected by the advertisement platform 128 transmitted via network 108. In some embodiments, website host 104 can include advertisement platform 128. In various embodiments, the ad content can be also hosted on multiple advertisement servers and the web browser application can issue one or more requests to different advertisement servers to obtain the ad.

Next, block 216 transmits the selected ad and the requested web page. This can be performed in any suitable way. For example, website host 104 can transmit information regarding the requested web page and the advertisement to client device 102 via network 108.

Finally, block 218 receives the web page and selected ad. This can be performed in any suitable way. For example, browser 114 can receive code via network 108 to enable it to render the web page and the advertisement.

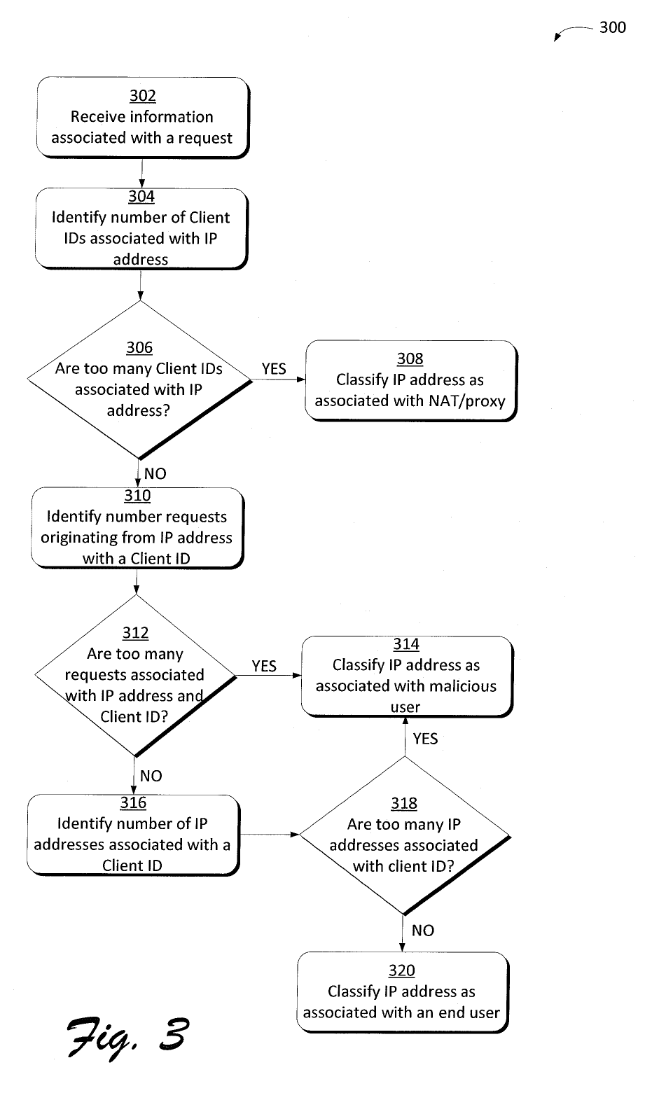

FIG. 2 describes a general process in which an ad is served responsive to a request for a web page. In various embodiments of FIG. 2, selection of the advertisement to be served is based at least in part on a classification of an IP address from which the request was received. FIG. 3 describes various embodiments of classifying the IP address.

In particular, FIG. 3 illustrates an example process 300 for classifying an IP address based on information received as part of the request for the web page. The process can be implemented in connection with any suitable hardware, software, firmware; or combination thereof. In at least some embodiments, the process can be implemented in software, such as advertisement platform 128.

Block 302 receives information associated with a request for an advertisement. This can be performed in any suitable way. For example, advertisement platform 128 can receive an IP address of an end user system (e.g., a device that requested the web page of which the advertisement will be a part such as client device 102), a client identifier (e.g., a client ID, machine unique identifier (MUID), GUID, user ID such as a username for a service, or identification information included in a cookie), and/or a request identifier or request global user identifier (RGUID). The information associated with the request can be, for example, received by a website host 104 as part of a request for a web page and included in the ad call transmitted from the website host 104 to or otherwise processed by the advertisement server 106.

Next, block 304 identifies a number of client IDs associated with the IP address. This can be performed in any suitable way. For example, advertisement platform 128 can associate each client ID received with the IP address from which it was received and determine a number of client IDs associated with any given IP address.

Block 306 determines if too many client IDs are associated with the IP address. This can be performed in any suitable way. For example, the number of client IDs associated with an IP address can be compared to a threshold number of client IDs. The threshold can vary depending on the particular embodiment. For example, a threshold can be from between five and twenty-five, inclusive, client IDs associated with a single IP address. The threshold enables multiple devices or multiple users to utilize a single IP address. For example, a household utilizing a wireless router can have single IP address assigned to the router. Various devices within the household, such as one or more desktop computers, laptops, and other wireless devices, can connect to the router. A request for a web page from any device connected to the router will include the IP address of the router, and the router can determine which specific device requested the web page. The threshold can be determined such that households having various devices connected to the router are not classified as being associated with a NAT or proxy.

When the number of client IDs associated with the IP address is greater than the threshold, block 308 classifies the IP address as being associated with a NAT or proxy. This can be performed in any suitable way. For example, advertisement platform 128 can store the IP address in a list identifying the IP address as being associated with a NAT or proxy.

If, however, the number of client IDs associated with the IP address is below the threshold number of client IDs, block 310 identifies the number of requests originating from the IP address and each client ID. This can be performed in any suitable way. For example, advertisement platform 128 can sort requests received from each client ID and IP address and determine a number of requests received from a given IP address and client ID pair.

Block 312 determines if too many requests are associated with the client ID and IP address pair. This can be performed in any suitable way. For example, the number of requests associated with a client ID and IP address can be compared to a threshold number of requests. The threshold can vary depending on the particular embodiment. For example, a threshold can be from between five and twenty-five, inclusive, requests associated with a client ID and IP address pair.

When the number of requests associated with the client ID and IP address pair is greater than the threshold, block 314 classifies the IP address as being associated with a malicious user (either confirmed or suspected). This can be performed in any suitable way. For example, advertisement platform 128 can store the IP address in a list identifying the IP address as being associated with malicious or fraudulent users, sometimes referred to as a black list. In some embodiments, the IP address can be classified as being associated with a compromised system (e.g., a system that may be used later for a malicious attack). In some embodiments, the IP address can be classified as test traffic, or traffic passed through the system (e.g., to verify a functionality) not charged for (e.g., marked it as “un-billable”).

If, however, the number of requests associated with the client ID and IP address pair is below the threshold number of requests, block 316 identifies the number of IP addresses associated with a client ID. This can be performed in any suitable way. For example, advertisement platform 128 can sort client ID and IP address pairs by client ID to determine a number of IP addresses associated with a client ID.

Block 318 determines if too many IP addresses are associated with the client ID. This can be performed in any suitable way. For example, the number of IP addresses associated with a client ID can be compared to a threshold number of IP addresses. The threshold can vary depending on the particular embodiment. For example, a threshold can be from between five and twenty-five, inclusive, IP addresses associated with a single client ID. The threshold enables a user to utilize multiple devices. For example, user may use the same client ID to access a service using a computer at work, a laptop computer at home, and a smartphone, each of which is associated with a different IP address.

When the number of IP addresses associated with the client ID is greater than the threshold, block 314 classifies the IP address as being associated with a malicious user. This can be performed in any suitable way. For example, advertisement platform 128 can store the IP address in a list identifying the IP address as being associated with malicious or fraudulent users (confirmed or suspected), sometimes referred to as a black list.

If, however, the number of IP addresses associated with the client ID is below the threshold number of requests, block 320 classifies the IP address as associated with an end user. This can be performed in any suitable way. For example, advertisement platform 128 can store the IP address in a list identifying the IP address as being associated with an end user.

The result of process 300 is a classification of an IP address into one of three classifications. In various embodiments, the IP address can be classified as being associated with a NAT or proxy, a malicious user, test traffic, or a legitimate end user. In some embodiments, IP addresses can be classified in other ways. In various embodiments, upon classifying the IP address, the advertisement platform can either select or not select an advertisement based at least in part on the classification of the IP address or further process the IP address.

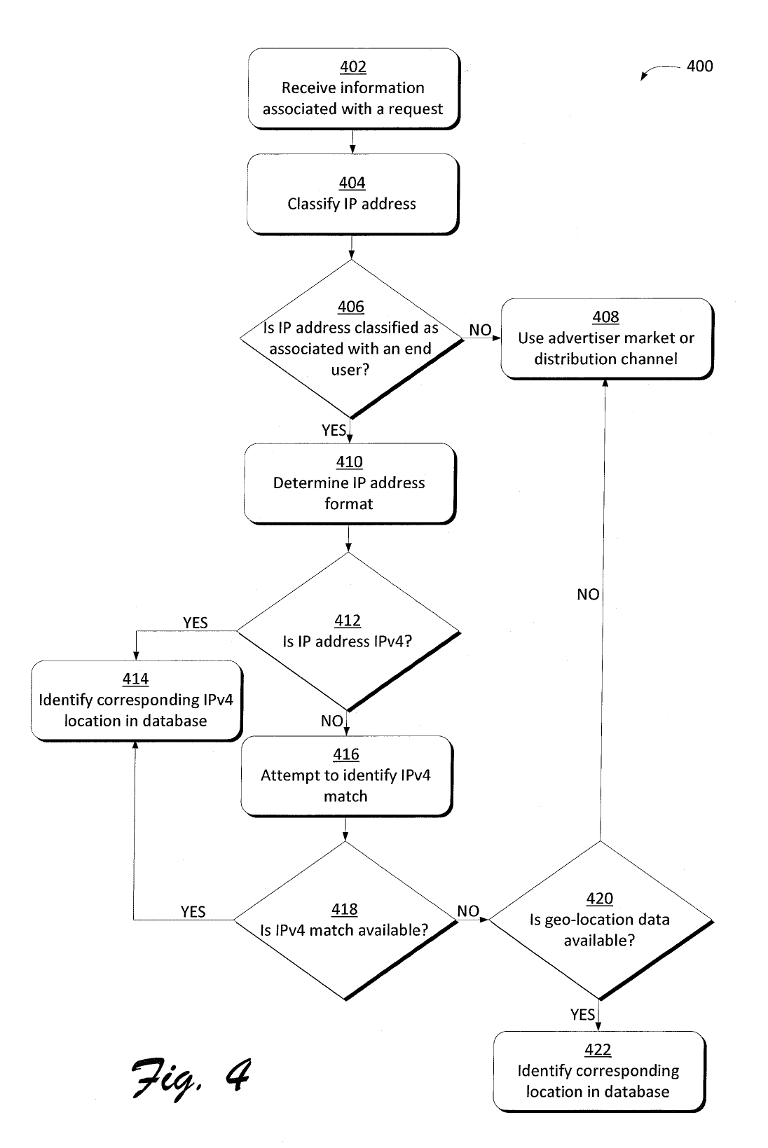

FIG. 4 illustrates an example process 400 for determining a geo-location for an IP address. The process can be implemented in connection with any suitable hardware, software, firmware, or combination thereof. In at least some embodiments, the process can be implemented in software, such as advertisement platform 128.

Block 402 receives information associated with a request for an advertisement. This can be performed in any suitable way. For example, advertisement platform 128 can receive an IP address of an end user system (e.g., a device that requested the web page of which the advertisement will be a part such as client device 102), a client identifier (e.g., a client ID, machine unique identifier (MUID), GUID, user ID such as a username for a service, or identification information included in a cookie), and/or a request identifier or request global user identifier (RGUID). The information associated with the request can be, for example, received by a website host 104 as part of a request for a web page and included in the ad call transmitted from the website host 104 to the advertisement server 106.

Next, block 404 classifies the IP address. This can be performed in any suitable way, examples of which are provided above and below. For example, process 300 can be used to classify the IP address based on the information received at block 402. In various embodiments, process 400 is not conducted for IP addresses classified as malicious or fraudulent.

Block 406 determines if the IP address is classified as associated with an end user. This can be performed in any suitable way. For example, advertisement platform 128 can determine if the IP address has been classified as being associated with an end user or as a proxy or NAT.

If block 406 determines that the IP address is not classified as being associated with an end user (e.g., the IP address is associated with a NAT or proxy), block 408 can use advertiser market or distribution channel information to identify a location for the IP address. This can be performed in any suitable way. For example, call information or other information included in the request (e.g., a language in which the browser is configured to present information to a user) can indicate a general geographic location. For example, in embodiments in which the browser is configured to present information in British English, the IP address can be associated with the United Kingdom and an advertisement targeted to the British market can be selected. In various embodiments, an advertiser market or distribution channel can be used to identify a location associated with the IP address because there is a low level of confidence that the location of the IP address is also the location of the end user. For example, some Internet service providers (ISPs) may route traffic from users of their service through a NAT or proxy such that users from across a country can be associated with an IP address at a single location. While the location of the NAT or proxy may be close in proximity to the location of some users, it may be inaccurate for a large percentage of the users.

If, however, block 406 determines that the IP address is associated with an end user, block 410 determines the IP address format. This can be performed in any suitable way. For example, advertisement platform 128 can determine if the format of the IP address is in a format consistent with an Internet Protocol Version, e.g., Internet Protocol Version 4 (IPv4) or Internet Protocol Version 6 (IPv6). Other formats for the IP address can be identified, depending on the particular embodiment.

Block 412 determines if the IP address is in an IPv4 format. If the IP address is in an IPv4 format, block 414 can identify a corresponding location for the IPv4 address in a database. This can be performed in any suitable way. For example, advertisement platform 128 can find a location that corresponds to the IPv4 address in a database on advertisement server 106 or on another server having a geo-location database that maps the IPv4 address to a country, city, state, zip code, or other geo-location indicator.

If, however, the IP address is not in an IPv4 format, for example, because the IP address is in an IPv6 format, block 416 attempts to identify an IPv4 match for the IP address. This can be performed in any suitable way. For example, the IP address can be associated with a client identifier that is associated with an IP address in IPv4 format in a database. Because both the IP address received by block 402 and the IPv4 IP address in the database are associated with the same client identifier, a match can be identified.

Block 418 determines if an IPv4 match is available. If an IPv4 match for the IP address is available, block 414 identifies a corresponding IPv4 location in the database. This can be performed in any suitable way, examples of which are provided above.

If an IPv4 match is not available, block 420 determines if geo-location data for the IP address is available. This can be performed in any suitable way. For example, advertisement platform 128 can determine if geo-location information is associated with the IPv6 address in a database.

If geo-location data is available, block 422 identifies a corresponding location in the database. This can be performed in any suitable way. For example, advertisement platform 128 can find a location that corresponds to the IP address in a database on advertisement server 106 or on another server having a geo-location database that maps the IP address to a country, city, state, zip code, or other geo-location indicator.

If block 420 determines that geo-location information is not available, the process proceeds to block 408 and advertiser market or distribution channel information can be used to associate a location with the IP address, as described above.

The order of geo-location lookup/logic can be performed in different formats in different embodiments. For example, the advertising system may want to look for IPv6 address because of a high level of confidence to accuracy of IPv6 geo-location data, and a secondary step can be perform an IPv4 look up (e.g., if no location data is available for IPv6). As another example, the advertising system can skip the IPv4 look up and proceed directly to a failsafe based on distribution market or other suitable defaults.

Consider the following example to further describe process 400. Assume an IPv6-enabled end user visits an IPv6-enabled website, xyz.com. Also assume that the end user's IPv6 address is new to the advertisement server. When the user visits xyz.com, xyz.com generates an ad request that is forwarded, along with user information, including the IPv6 address and a client identifier, to the advertisement server. Since the IPv6 address is new to the advertisement server, geo-location information is not available, the advertisement server selects an advertisement based on other information, such as the client identifier or advertiser market information. The selected advertisement is forwarded to xyz.com for display to the user. When published, the selected advertisement points to a redirect server “xyzredirect.com” hosted on an IPv4 address (e.g., routing the web client using an IPv4 address).

When the redirect system xyzredirect.com is hosted on an IPv4 address, the user's system requests the IPv6 record from the DNS server for the IPv4 redirect server. Since the DNS server does not have an IPv6 record for the IPv4 redirect server, the DNS server cannot respond and the end user's system can time out. After timing out, the end user's system can send a subsequent request, this request for an IPv4 address for the IPv4 redirect server. The DNS server locates the IPv4 address and the click is forwarded to the IPv4 redirect server.

In various embodiments, a resource (hosted on an IPv4 address) is embedded into the advertisement content, and the browser application requests the resource from IPv4 automatically without user selection.

The IPv4 redirect server (or the system that hosts the resource) receives the click information, including the IPv4 IP address of the end user and the client identifier for the end user, and forwards the end user to the landing page associated with the advertisement. The IPv4 redirect server logs or stores the IPv4 address of the end user along with the client identifier. Based on geo-location information available for the IPv4 address, geo-location data for the IPv6 address associated with the same client identifier can be populated and stored in the geo-location database. When the end user makes a subsequent visit to xyz.com from the same IPv6 IP address, the geo-location for the IP address will be available in the database.

In process 400, IP addresses can be associated with a geo-location to enable advertisements tailored to the location of the IP address to be served responsive to an ad call. In various embodiments, however, when an IP address is classified as being associated with a malicious or fraudulent user, advertisement platform can elect to not serve an advertisement or to record the serving of the advertisement in a way so as to identify the impression as non-billable to a client.

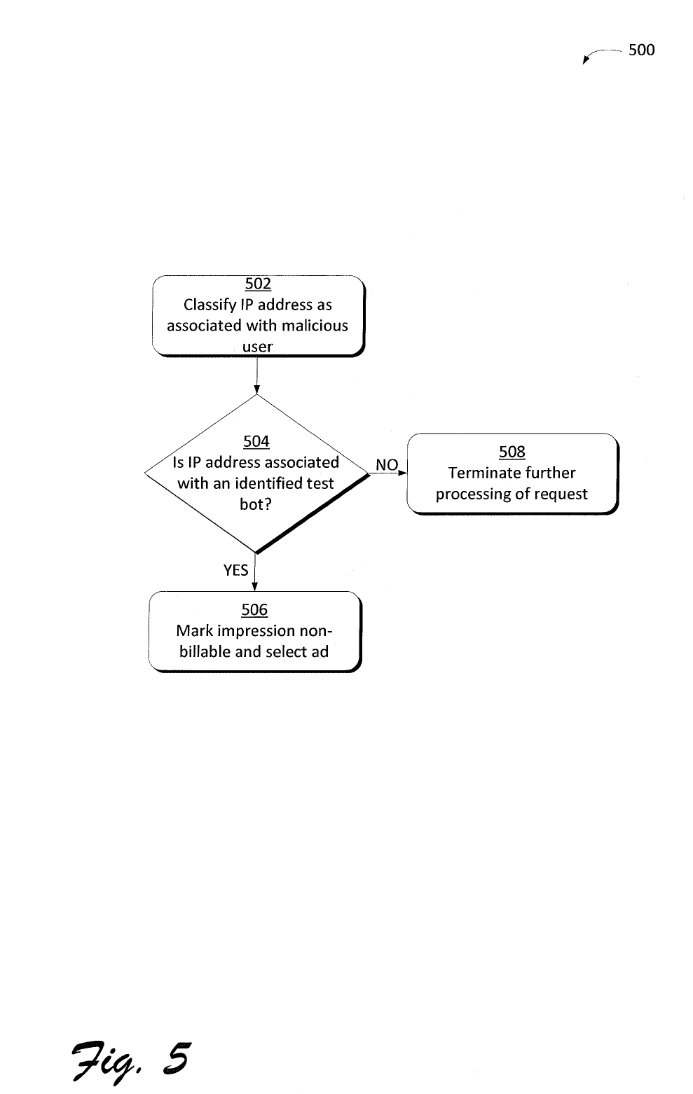

FIG. 5 illustrates an example process 500 for managing risk responsive to classifying an IP address as associated with a malicious or fraudulent user. The process can be implemented in connection with any suitable hardware, software, firmware, or combination thereof. In at least some embodiments, the process can be implemented in software, such as advertisement platform 128.

Block 502 classifies an IP address as associated with a malicious user. This can be performed in any suitable way. For example, advertisement platform 128 can classify an IP address as associated with a malicious user during process 300 or can otherwise determine that the IP address was previously classified as a malicious or fraudulent user or test bot. For example, the IP address can be on a black list, be a self-identified bot, or the IP address, client ID or user agent can correspond to an identified test bot.

Block 504 determines if the IP address is associated with an identified test bot. This can be performed in any suitable way. If the IP address is associated with an identified test bot, block 506 can mark the impression as non-billable and select an advertisement to be served. This can be performed in any suitable way. For example, advertisement platform 128 can identify the impression as a test such that the impression can be later excluded from being billed to the advertiser.

If block 504 determines that the IP address is not associated with an identified test bot, block 508 terminates further processing of the request for an advertisement. This can be performed in any suitable way. For example, advertisement platform 128 can terminate the request.

Various embodiments described above automatically classify IP addresses and use the classification to determine an applicable ad impression path. For example, when an IP address is classified as being associated with a NAT or proxy or an end user, additional processing can determine a geo-location associated with the IP address to enable an advertisement tailored to the location of a user to be served. As another example, when an IP address is classified as being associated with a malicious or fraudulent user or a test bot, the ad impression path can include marking the ad impression as non-billable or terminating the request without serving an advertisement. Though the ad impression path may vary, the various embodiments enable advertisements to be selected according to an IP address and to manage or control a number of advertisements served to an inappropriate audience (e.g., bots, malicious or fraudulent users, or users not associated with a location targeted by the advertisement). However, in some embodiments, validation of a classification can be used to confirm that the classification was correct, to predict the relevance of an advertisement, or to predict the probability of it getting viewed/clicked by an end-user. Validation can be achieved by processing selection path information.

Selection Path

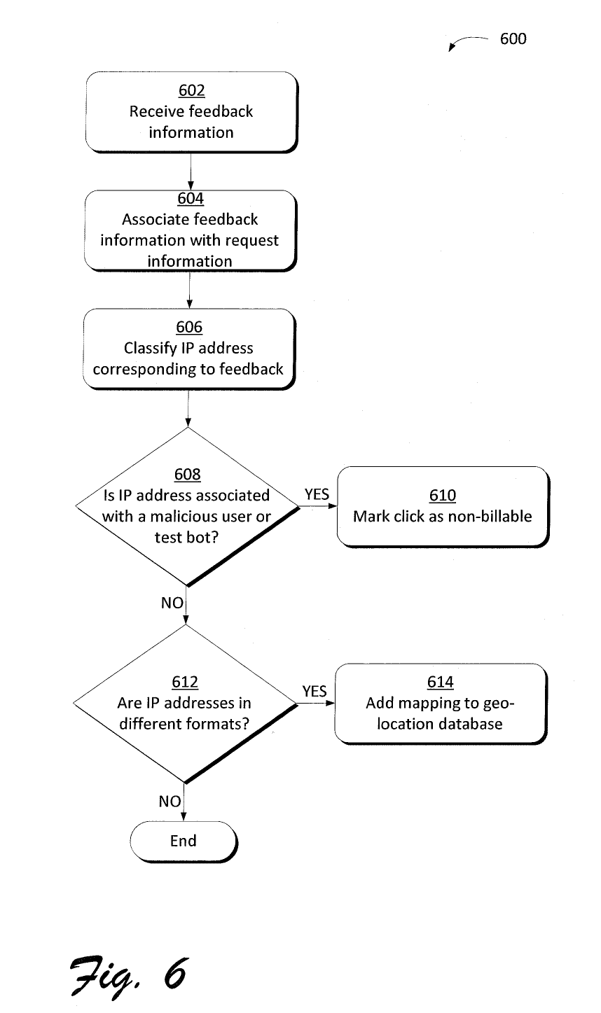

FIG. 6 depicts an example process 600 for using feedback information to validate IP classifications. The process can be implemented in connection with any suitable hardware, software, firmware, or combination thereof. In at least some embodiments, the process can be implemented in software, such as advertisement platform 128.

Block 602 receives feedback information. This can be performed in any suitable way. For example, when a service is consumed (e.g., a published ad is selected or clicked), advertisement platform 128 can receive feedback information that includes an IP address of an end user system (e.g., the system that consumed the service) and a RGUID corresponding to the served advertisement. Other or additional information can be received as part of the feedback information, depending on the particular embodiment.

Next, block 604 associates the feedback information received by block 602 with corresponding request information. This can be performed in any suitable way. For example, in various embodiments, the RGUID of a request for an advertisement (e.g., ad call) is the RGUID included in the feedback information. In such embodiments, advertisement platform 128 can match the feedback information with the request information by identifying a matching RGUID in a database. Thus, each RGUID is associated with an IP address corresponding to a request for an advertisement and an IP address corresponding to a selection of the advertisement.

Block 606 classifies the IP address corresponding to the feedback. This can be performed in any suitable way. For example, process 300 or a similar process can be used to classify the IP address.

Next, block 608 determines if the IP address is associated with a malicious user or a test bot. This can be performed in any suitable way. For example, advertisement platform 128 can determine if the IP address is on a black list or is a self-identified bot, or if the IP address, client ID or user agent correspond to an identified test bot.

If the IP address corresponding to the feedback is associated with a malicious user or test bot, block 610 marks the selection as non-billable. This can be performed in any suitable way. For example, advertisement platform 128 can identify the impression as a test such that the impression can be later excluded from being billed to the advertiser.

If the IP address is not associated with a malicious user or test bot (e.g., the selection is billable), block 612 determines if the IP addresses are in different formats. This can be performed in any suitable way. For example, advertisement platform 128 can determine if the format of the IP address associated with the feedback differs from the IP address associated with the request. In various embodiments, one IP address may be in an IPv4 format while the other may be in an IPv6 format. If the IP addresses are in the same format, processing ends.

If the addresses are in different formats, block 614 adds the mapping to the geo-location database. This can be performed in any suitable way. For example, advertisement platform 128 can associate the IPv6 address with the IPv4 address and the corresponding location of the IPv4 address to build the geo-location database.

Having described various embodiments in which IP addresses are automatically classified and classifications are used to determine an applicable ad impression path, consider an example device that can be used to implement one or more embodiments.

### Example Device

FIG. 7 illustrates various components of an example device 700 that can be implemented as any type of portable and/or computer device as described with reference to FIG. 1. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the embodiments described above. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716. The storage type computer-readable media are explicitly defined herein to exclude propagated data signals.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 718 also include any system components or modules to implement embodiments of the techniques described herein. In this example, the device applications 718 include an interface application 722 and a gesture-capture driver 724 that are shown as software modules and/or computer applications. The gesture-capture driver 724 is representative of software that is used to provide an interface with a device configured to capture a gesture, such as a touchscreen, track pad, camera, and so on. Alternatively or in addition, the interface application 722 and the gesture-capture driver 724 can be implemented as hardware, software, firmware, or any combination thereof. In addition, computer-readable media 714 can include an advertisement platform 725 that functions as described above.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and/or image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable storage devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

1. (canceled)

2. (canceled)

3. (canceled)

4. (canceled)

5. (canceled)

6. (canceled)

7. (canceled)

8. (canceled)

9. (canceled)

10. One or more computer-readable storage media comprising instructions that are executable to cause a device to perform a process comprising:
receiving a request for an advertisement from a requesting IP address;
classifying, based on received information associated with the request for the advertisement, the requesting IP address;
selecting the advertisement to be published responsive to the request;
receiving feedback from a feedback IP address;
classifying, based on received information associated with the feedback, the feedback IP address; and
associating the received information associated with the request with the received information associated with the feedback.

11. The one or more computer-readable storage media of claim 10, the process further comprising:
determining that a format of the requesting IP address differs from a format of the feedback IP address; and
adding a mapping of the requesting IP address and the feedback IP address to a geo-location database.

12. The one or more computer-readable storage media of claim 10, classifying the requesting IP address comprising classifying the requesting IP address as being associated with an end user or as being associated with a NAT or proxy.

13. The one or more computer-readable storage media of claim 10, wherein received information associated with the request for the advertisement comprises the requesting IP address, a client identifier, or a request global user identifier.

14. The one or more computer-readable storage media of claim 13, classifying the requesting IP address comprising classifying the requesting IP address as being associated with an end user responsive to determining a number of client identifiers associated with the requesting IP address is less than a threshold number of client identifiers, and responsive to determining a number of IP addresses associated with the received client identifier is less than a threshold number of IP addresses.

15. The one or more computer-readable storage media of claim 14, the process further comprising:
attempting to determine a location associated with the requesting IP address.

16. The one or more computer-readable storage media of claim 15, selecting the advertisement comprising using advertiser market or distribution channel information to select the advertisement responsive to being unable to determine the location associated with the requesting IP address.

17. The one or more computer-readable storage media of claim 10, wherein classifying the feedback IP address comprises classifying the feedback IP address as being associated with a malicious user; the process further comprising:
marking the received feedback as non-billable.

18. The one or more computer-readable storage media of claim 16, the process further comprising:
adding at least one of the feedback IP address and the requesting IP address to a list of known malicious users.

19. A device comprising:
one or more processors;
one or more computer-readable storage media; and
one or more modules embodied on the one or more computer-readable storage media and executable under the influence of the one or more processors, the one or more modules configured to:
classify, based on received information associated with a request for an advertisement, a requesting IP address as being associated with an end user;
select the advertisement to be published responsive to the request;
receive feedback from a feedback IP address that indicates a user interaction with the advertisement;
associate the received information associated with the request with received information associated with the feedback; and
classify, based on the received information associated with the feedback, the feedback IP address effective to validate the classification of the requesting IP address.

20. The device of claim 19, wherein the user interaction with the advertisement comprises selection of the advertisement.

21. A method implemented in a computing device, the method comprising:
receiving a request for an advertisement from a requesting IP address;
classifying, based on received information associated with the request for the advertisement, the requesting IP address;
selecting the advertisement to be published responsive to the request;
receiving feedback from a feedback IP address;
classifying, based on received information associated with the feedback, the feedback IP address; and
associating the received information associated with the request with the received information associated with the feedback.

22. The method of claim 21 further comprising:
determining that a format of the requesting IP address differs from a format of the feedback IP address; and
adding a mapping of the requesting IP address and the feedback IP address to a geo-location database.

23. The method of claim 21, the classifying the requesting IP address comprising classifying the requesting IP address as being associated with an end user or as being associated with a NAT or proxy.

24. The method of claim 21, wherein received information associated with the request for the advertisement comprises the requesting IP address, a client identifier, or a request global user identifier.

25. The method of claim 24, the classifying the requesting IP address comprising classifying the requesting IP address as being associated with an end user responsive to determining a number of client identifiers associated with the requesting IP address is less than a threshold number of client identifiers, and responsive to determining a number of IP addresses associated with the received client identifier is less than a threshold number of IP addresses.

26. The method of claim 25 further comprising attempting to determine a location associated with the requesting IP address.

27. The method of claim 26, the selecting the advertisement comprising using advertiser market or distribution channel information to select the advertisement responsive to being unable to determine the location associated with the requesting IP address.

28. The method of claim 21, wherein classifying the feedback IP address comprises classifying the feedback IP address as being associated with a malicious user; the process further comprising:
marking the received feedback as non-billable.

29. The method of claim 27 further comprising adding at least one of the feedback IP address and the requesting IP address to a list of known malicious users.
